(19) United States
(12) Patent Application Publication
(10) Pub. No.: US 2020/0278233 A1
(43) Pub. Date: Sep. 3, 2020

(54) Electro-Pneumatic Volumetric Meter

(71) Applicant: Antonio Salinas Valero, Sao Paulo (BR)

(72) Inventor: Antonio Salinas Valero, Sao Paulo (BR)

(21) Appl. No.: 16/803,755

(22) Filed: Feb. 27, 2020

(30) Foreign Application Priority Data
Mar. 1, 2019 (BR) 10 2019 004311-3

(51) Int. Cl. G01F 11/12

(52) U.S. Cl. CPC G01F 11/12

(57) ABSTRACT

This invention concerns a volumetric meter used to measure the empty volume of a reservoir/tank (RT) in automobiles, industrial reservoirs, and others, which may be irregular in shape, undeformable and hermetic, stationary or moving, flat or on an incline. This innovative electro-pneumatic volumetric meter allows the volume of the contents of a reservoir/tank to be measured precisely.

### CROSS-REFERENCE TO RELATED APPLICATION

This application claims priority to Brazilian patent application no. BR 10 2019 004311 3, filed on Mar. 1, 2019, the contents of which are incorporated herein by reference in their entirety.

### FIELD OF THE INVENTION

This invention concerns an electro-pneumatic volumetric meter, in particular, one having innovative useful characteristics that allow the empty volume of automobile reservoirs/tanks, industrial reservoirs, and others to be measured, even if their shapes are irregular, whether they are undeformable, hermetic, stationary or moving, flat or on an incline, and this innovative electro-pneumatic volumetric meter allows the volume of the contents of the reservoir/tank to be measured precisely.

### BACKGROUND OF THE INVENTION

It is known that the volume of tanks/reservoirs must be measured in order to know the quantity of products used so that production can be defined, the available volume can be measured, or the inventory of stored liquid can be managed, such as, for example, calculating the volume of liquids such as diesel, ethanol, gasoline, kerosene, alcohols, and other hydrocarbons that are in a cylinder that forms a tank.

To this end, there are currently several models of volumetric meters on the market, such as differential pressure flow meters, which may be used to measure the majority of gases, liquids, fluids with suspended solids, and viscous fluids, however there is an unrecoverable loss of load.

There are other models of flow meters, such as, for example, those in document number PI 0302364-8, which concerns an oscillating piston fluid flow meter. This sensor contains a cylindrical measuring chamber that includes a side wall, a bottom and a lid, a lower cylinder and an upper cylinder that have the same diameter, which is smaller than the diameter of the chamber, an entry orifice and an exit orifice to respectively allow in and to evacuate fluid from that chamber, a cylindrical piston placed eccentrically and guided kinetically inside that chamber, and oscillating within that chamber as a result of the displacement of fluid volume, and a fixed divider between the entry orifice and the exit orifice that is positioned radially between the side wall and the lower and upper cylinders, and axially positioned between the bottom and the lid; the side wall includes a vertical cavity in the area next to the fixed divider. That cavity is separated from the entry and exit orifices, and passes through the side wall at least partially within the height of the wall.

Another document, number PI 0803986-0, concerns an autonomous flow meter for liquid fuels to be placed between the fuel pump's outlet fitting and the hose. That device is intended to measure, volumetrically, the liquid fuel that is transferred from the tank at the filling station to a container or to a vehicle's fuel tank whenever the pump is activated, and it is comprised of a sensor, a chamber, a pair of oval cogs, four magnets, a magnetic switch, a CPU, an integrated circuit board, an accelerometer, a battery, a tubular body, a casing, and a seating.

Document number CN207703283 concerns a volumetric flow meter, including an upper lid, barrel and lower lid. The upper lid is installed on the upper end of this barrel, and the lower lid is installed at the lower end. The interior of the upper lid has a guide plate corresponding to the inlet. The upper barrel-shaped portion rises towards the opening, and the lower portion opens downwards.

### DESCRIPTION OF THE DRAWINGS

In addition to this description, in order to better understand the characteristics of this invention, and according to its preferred use, a set of drawings showing its operation by way of example and without limitation is appended hereto:

FIG. 1 shows a schematic view of the volumetric meter according to the invention.

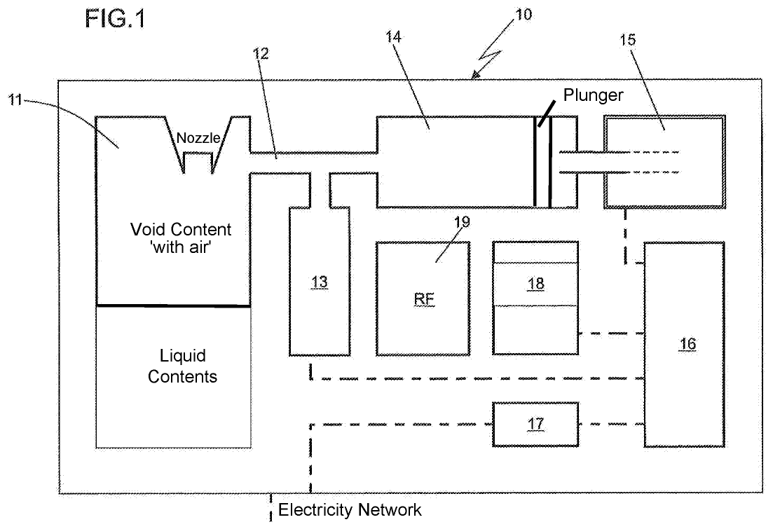

### DESCRIPTION OF THE INVENTION

Regarding the drawings, this invention concerns an “ELECTRO-PNEUMATIC VOLUMETRIC METER,” particularly a volumetric meter (10) used to measure the empty volume of a reservoir/tank (11) for automobiles, industrial reservoirs, and other types of tanks, which may be irregular in shape, undeformable and hermetic, stationary or moving, flat or on an incline.

According to this invention, the volumetric meter (10) is comprised of a reservoir/tank (11) that is connected to a lung/air piston (14) using pipes or air hoses (12), in which the piston is, in turn, moved by an actuator (15). A pressure sensor (13) is connected to the aforementioned assembly, which completes and allows the movement of air to be recorded and pressure to be sensed by the aforementioned assembly.

An electronic command and control module (16) is connected by electric wires to the equipment: i) a pressure sensor (13) that senses and reads the pressure at the start of the scan in order to obtain the pressure in the system at this stage, such that each time the actuator (15) is activated in conjunction with the lung/piston (14), there is expulsion and/or return of air to the tank (11); ii) panel (18) designed to show the result of the volume scan on the LCD screen; iii) power source (17) that connects the meter (10) to the power grid (not shown), such that when there is electricity available at 12V, the power source (17) is disconnected and the module (16) is connected directly to the network.

The meter (10) also allows for remote control (19) with an LCD display which, using a radiofrequency (RF) signal, shows the result of the scan and commands the connection/disconnection of the system from the module (16). The data obtained by the module (16) is stored in the memory of the command and control module (16), which performs the calculations and shows the results.

The set of rules for sequencing the abovementioned calculations is comprised of the following:

a) Constant fixed memory—MF

MF 01 ml—Tank volume that may be measured during the first installation operation;

MF 02 ml—Lung/piston volume that includes calculating the volume over the trajectory of the plunger and the area of the piston of the lung/piston.

b) Reading memory—readings from the pressure sensor

ML11 Pa—initial pressure;

ML12 Pa—final pressure.

c) Temporary memory—of calculations—MT

MT21 Pa—Pressure difference=((ML12) (−) (ML11));

MT22 um—Quotient=((MF12) (/) (MT21));

MT23 ml—Empty volume=((MF02) (*) (MT22));

MT24—Tank contents=((MF01) (−) (MT23))

During installation, the (value of MT23—empty volume) corresponds to the total volume of the ‘dry’ tank, which value will be saved in the MF01—tank volume.

d) Records from the LCD display

MP31—Previous (Contents of prior scan);

MP32—Current (Contents of Current Operation);

MP33—Consumption/Abst=((MP31) (−) (MP32)).

Updates the display records prior to saving the current data to be transferred from (MP32) to (MP31). Data from prior measurement.

In order to allow the Operating Command Sequence of the equipment to be performed by the command and control module (16), the equipment must first be connected to the power grid or to the 12V power source, then the following steps must be taken:

1^{st} step—Turn on the module (16) using the ‘on’ button of the remote control or the affixed panel (18);

2^{nd} step—Only upon installation of the meter (10) or if there are changes in the volume of the lung/piston (14). Input MF02—Volume of lung/piston (14) using the keyboard;

3^{rd} step—Read the sensor and save in ML11 ‘Press Initial;

4^{th} step—Turn on the actuator (15), which will ‘discharge’ an amount (ml) of air from the lung/piston (14) in the direction of the tank (11); this operation increases the ‘normal’ pressure of the tank (11);

5^{th} step—Read the pressure sensor (13) and save in ML 12 ‘Press Final’;

6^{th} step—Turn on the actuator (15) (which sucks out that quantity (ml) of air to the lung/piston (14)), which operation returns the tank (11) to its ‘normal’ pressure;

7^{th} step—Calculate ((ML12) (−) (ML11))—save the result in MT21 ‘press difference’;

8^{th} step—Calculate ((ML11((/) (MT21))—save the result in MT22 ‘quotient’;

9^{th} step—Calculate ((MF02) (*) (MT22))—save the result in MT23 ‘Void Volume’;

10^{th} step—Calculate ((MF01) (−) (MT23))—save the result in MT24 ‘tank (11) contents’;

11^{th} step—Transfer—save the contents of (MP32—Current, in (MP31 ‘Prior’);

12^{th} step—Transfer—save the contents of (MT24—‘Content’ in (MP32 ‘current’);

13^{th} step—Calculate (MP32 (−) MP31)—save in MP33 ‘Consumption/Supply’.

When this invention is placed into service, modifications may be introduced in regard to certain details of construction and form without this changing the principal fundamentals that are clearly substantiated in the claims table, thus it is understood that the terminology used is not intended to impose limitations.

1. A volumetric meter comprising:
a reservoir/tank connected by tubes or air hoses to a lung/air piston, wherein the lung/air piston is configured to be moved by an actuator;
a pressure sensor connected thereto to an assembly comprising the reservoir/tank, the tubes or air hoses, the lung/air piston and the actuator, wherein the pressure sensor is configured to allow movement of air to be recorded and senses pressure in the assembly;
an electronic command and control module that is connected by electric wires attached to the assembly wherein the pressure sensor senses the pressure each time the actuator is turned on, which, in conjunction with the lung/piston once started, at least one of suctions air from the reservoir/tank or returns air to the reservoir/tank;
a display that is designed to display a result of a volume scan;
a power source that connects the volumetric meter to a power grid, wherein in response to energy being available at 12 volts, the power source is disconnected and the electronic command and control module is connected directly to an electricity network, wherein the volumetric meter is configured to be controlled via a remote control with a liquid crystal display (LCD) that indicates the result of the volume scan using a radiofrequency signal (RF), and controls an on/off function of the electronic command and control module, wherein data obtained by the pressure sensor is stored in a memory in the command and control module, wherein the command and control module performs calculations and displays results of the calculations.

2. The volumetric meter of claim 1, further comprising a set of rules for sequencing empty volume calculations in the reservoir/tank, where:
constant fixed records—MF
MF 01 ml—tank volume that may be measured during an installation operation;
MF 02 ml—lung/piston volume that includes calculating a volume of a trajectory of a plunger and a piston area in a lung/piston assembly;
memory of readings—reading of the lung/piston—ML,
ML11 Pa—initial pressure;
ML12 Pa—final pressure;
temporary memory—of calculations—MT
MT21 Pa—pressure difference=((ML12) (−) (ML11));
MT22 um—quotient=((MF12) (/) (MT21));
MT23 ml—empty volume=((MF02) (*) (MT22));
MT24—tank contents=((MF01) (−) (MT23));
records on the LCD display
MP31—previous (contents of prior scan);
MP32—current (contents of current operation);
MP33—consumption/Abst=((MP31) (−) (MP32)).

3. The volumetric meter of claim 1, wherein the volumetric meter is an electro-pneumatic volumetric meter.

4. The volumetric meter of claim 1, wherein the volumetric meter is used to measure empty volume of the reservoir/tank in at least one of automobiles or industrial reservoirs, wherein the at least one of automobiles or industrial reservoirs are at least one of irregular in shape, undeformable and hermetic, stationary or moving, flat or on an incline.

5. The volumetric meter of claim 1, wherein the electronic command and control module is coupled to the pressure sensor, the display, the actuator, and the power source.
